(19) United States
(12) Patent Application Publication
(10) Pub. No.: US 2017/0083920 A1
(43) Pub. Date: Mar. 23, 2017

(54) HYBRID METHOD OF DECISION TREE AND CLUSTERING TECHNOLOGY

(71) Applicant: FAIR ISAAC CORPORATION, Roseville, MN (US)

(72) Inventors: Scott M. Zoldi, San Diego, CA (US); Heming Xu, San Diego, CA (US); Yuting Jia, San Diego, CA (US)

(73) Assignee: FAIR ISAAC CORPORATION, Roseville, MN (US)

(21) Appl. No.: 14/860,306

(22) Filed: Sep. 21, 2015

(51) Int. Cl. G06Q 20/40; G06N 99/00

(52) U.S. Cl. CPC G06Q 20/4016; G06N 99/005; G06Q 2220/00

(57) ABSTRACT

A computer-implemented method of fraud detection includes clustering samples on the tree nodes in the decision tree model on the training dataset, calculating the cluster centroids and determining the high fidelity radius for a preset threshold probability for each cluster and determining the left-over class probability for each node. The new transactional data is classified in three steps: first to determine based on the decision tree what leaf node the transaction is associated, second to determine the membership to a cluster of the leaf node using the shortest distance to the cluster centroid and then third to compare the distance with the high fidelity radius and then to determine the eventual class probability for a new data. The new method demonstrates better performance than the decision-tree alone model.

### TECHNICAL FIELD

The present invention relates to computer software and payment transaction analysis. More particularly, the present disclosure relates to the use of machine learning methods for detecting fraudulent transactions in computerized systems.

### BACKGROUND

The task of detecting and recognizing fraud in payment transactions is a challenging subject in the industry. The schemes that fraudsters use may include, without limitation, application fraud, counterfeit, friendly fraud, skimming, internet/mail/phone order fraud, and lost/stolen transaction devices, etc. The task involves using a system to characterize the transactions and identify an underlying reason(s) in fraudulent transactions. Generally, real time payment transactions are processed by a card processor to determine whether the transactions are legitimate or fraudulent based on fraud detection models installed at and/or used by such card processor. Examples of such fraud detection models are provided by the Falcon® fraud detection models, developed by FICO, Inc. of San Jose, Calif. The fraud indicators (reasons) from these models may include transaction times, locations and amounts, and merchant categories. The historical transaction datasets with nonfraud or fraud labels are important in determining whether new transactions are fraudulent or legitimate.

A key technique used to detect and thwart transaction fraud is employment of fraud detection systems that are based upon a machine learning approach. For instance, machine learning detection systems assign to a transaction a score or probability that the transaction is fraudulent. In this approach, historical transaction datasets are used to construct predictive models, and features are typically extracted from the characteristics of historical transaction datasets in which transactions have been classified as either fraud or nonfraud. A learning model is built and applied to discriminate probabilistically between the two classes (nonfraud and fraud) on new transactions. Improvements in detection capability are highly desirable in order to facilitate in mitigating the monetary loss due to frauds.

Various algorithms may be used to implement the detection model. One of the more prominent learning models used by many card issuers is the Falcon® model, which uses neural network classification models executed by a computer processor. Historical transactions with labels are fed into the neural network and a probability of fraud is calculated by summing up all the contributions from the relevant neural nodes.

A decision tree learner (e.g. C4.5) is another popular tool for classification and prediction in the form of a tree structure. There are two types of nodes in such a tree: a leaf (terminal) node which does not have any branch, and a decision node which has branches and so subtrees. Classifiers are represented as trees in which a leaf node indicates the value of the target attribute (class classification) of examples, and a decision node specifies some condition to be carried out on a single attribute-value, with one branch and sub-tree for each possible outcome of the condition. Some of the benefits of a decision tree are that the tree structure provides a clear indication of which features (variables, attributes and features are used interchangeably) are most important for prediction or classification, and the tree structure provides a clear picture of which features are traversed together to reach a leaf node.

The algorithms of decision tree learners have been continuously developed and extended to include more features and yield a better performance for both supervised learning and unsupervised learning. For example, the original training data may be first clustered based on features (ignore labels) so the initial domain is decomposed into a few small subdomains. On each subdomain a decision tree is built only on the local partition of the training dataset, and thus each new data is evaluated in two tandem stages, including clustering and decision tree evaluation.

In a classical decision tree model, the leaf node classifies the data, i.e., the majority class among all the classes (which may be more than two) in the samples characterizing the classification of the leaf node, and the percentage of the classification class defines a likelihood which is only dependent on the counts of each class. New data traverses a pathway from the root to the leaf node and gets classified by a predetermined likelihood of each class.

### SUMMARY

This document describes a system and method that is able to better classify the data at a tree node, using a clustering technique based on feature vectors, instead of simply counting the numbers of the individual labels. Such a method uses additional feature information in the training data and test data, which improves the classification results.

Accordingly, a method and system are presented combining a decision tree learner and clustering method. In preferred implementations, cluster analysis is used, in which the objective is to group together objects or records that are as similar as possible to one another in the same cluster, and objects in different clusters are as dissimilar as possible, based on some measures in the feature space. The clustering approach aims to explore the distribution of the dataset and depict the intrinsic structure of data by organizing data into similarity groups or clusters.

Specifically, a clustering approach is applied to the training samples in a leaf node (or decision node) and to group the training samples into a plurality of subsets (clusters). New data traverse the tree and will be classified by determining the memberships to each cluster and the characteristics of the cluster to improve the predictability of the decision tree model.

In some aspects, a computer-implemented method and a system for detecting fraud in a plurality of transactions in a dataset includes a set of operations or steps, including building a decision tree with training data in the dataset. The training data includes data representing the plurality of transactions, the decision tree having one or more tree nodes comprising one or more leaf nodes that indicate a value of a target attribute value and one or more decision nodes that specify a condition to be executed by at least one data processor on a single target attribute value of one or more leaf nodes, and having branches that logically connect pairs of the one or more leaf nodes and/or decision nodes. A method and system further includes storing a plurality of samples of an output of the condition executed on the single target attribute value, and clustering, according to a clustering algorithm, the plurality of samples on related tree nodes to generate one or more clusters of sample. For each of the one or more clusters on each related tree node, a centroid for each cluster is calculated, and a high-fidelity radius is calculated for each cluster for a class probability threshold and a left-over class probability on the related tree node to define a set of clustering parameters. A method and system further includes applying the set of clustering parameters on new data to the dataset to classify the new data as either the class probability of a specific cluster of the one or more clusters or the left-over class probability associated with the leaf node.

To the accomplishment of the forgoing and related ends, certain illustrative aspects of implementations are described herein together with the following descriptions and drawings from which novel features and advantages of the system and method may become readily apparent.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings:

FIG. 1 shows a block diagram of transaction classification system in accordance with one aspect.

FIG. 2 shows another block diagram of transaction classification system in accordance with an aspect of an embodiment.

FIG. 3 shows an exemplary tree structure used to classify transactions.

FIG. 4 illustrates an exemplary distribution of data using the k-means algorithm.

FIG. 5 depicts an exemplary distribution of class probability in cluster 1 of FIG. 4 with respect to distance (radius) from the cluster centroid.

FIG. 6 is an illustration of graphs that depict performance comparison of two models.

FIG. 7 illustrates the performance variation with the probability threshold.

When practical, similar reference numbers denote similar structures, features, or elements.

### DETAILED DESCRIPTION

This document describes a system and method that combines a decision tree learner and a clustering technique. The system and method are able to better classify data at a tree node, using the clustering technique based on feature vectors, instead of simply counting the numbers of the individual labels. Such system and method use additional feature information in the training data and test data, which further improves the classification results.

In some preferred implementations, cluster analysis is used in which objects or records that are as similar as possible to one another are grouped together in the same cluster, and objects in different clusters are as dissimilar as possible, based on some measures in the feature space. The clustering approach explores the feature distribution of the dataset and depicts the intrinsic structure of data by organizing data into similarity groups or clusters.

Specifically, a clustering approach is applied to the training samples in a leaf node (or decision node) and to group the training samples into a plurality of subsets (clusters). New data traverse the tree and is classified by determining the memberships to each cluster and the characteristics of the cluster to improve the predictability of the decision tree model.

In some implementations, a novel computer-implemented system and method for classifying transactions is disclosed. Decision trees embedded with clustering classifiers are leveraged to provide enhanced fraud detection, utilizing the inherent feature distribution and grouping samples into subsets at the leaf or decision nodes. A preferred implementation incorporates a computer-implemented method for performing classifications of transaction samples that includes using a hybrid method with both a decision tree technique and clustering scheme on the tree nodes.

The decision tree is built from a training dataset, and feature characteristics on each transversal node carry signatures of the feature distribution in the samples. A decision tree classifier counts the number of samples reached at the leaf nodes, and the nodes are classified according to the populations of the classes. A likelihood of each class at each leaf node is predetermined by the training dataset.

The system or method described herein augments the capability of fraud detection of a decision tree by combining a classification capability with a clustering scheme on the features on the transversal nodes. In some implementations, a method includes the steps of: building a decision tree and calculating the cluster centroids of the classes in the feature space at each node along a pathway in the training phase; calculating a high fidelity radius for each cluster at nodes; calculating a left-over class probability based on the samples which are outside all the high-fidelity radius regions; traversing a new data sample through the nodes in the trained tree; calculating the Euclidean distance of this sample to the centroid of each cluster at a node; determining membership of the sample according to the closeness to each centroid; further comparing the Euclidean distance with the high fidelity radius; and determining a class probability, which is the threshold probability or the leftover class probability, based on whether the sample is located inside the radius or outside.

The cluster centroids are calculated by averaging the samples for each feature:

$$cluster center = 1 / N {\sum }_{i = 1}^{N} Xi$$

where N is the total number of samples in the cluster at a decision or leaf node and Xi are the features.

In some implementations, training samples at tree nodes are clustered based on a similarity in the feature space, without reference to the class tags. This is a generalized method over the clustering algorithm based upon the target class. Other implementations may be insensitive to noise or occasional misclassification.

In some implementations, a clustering approach like a K-means method utilizes the distance to all the cluster centroids to determine membership by the closest cluster. New data is assigned to that cluster in which the average distribution of the samples in that cluster determines the class probability for the new data.

The class probability varies with distance (radius) from the cluster centroid. This clustering approach leaves out variations of the class probability on the spread of the cluster, resulting in a coarse-grained average probability for a new data. According to one implementation, the class variation versus distance contains rich and insightful information of the feature distribution, and such information may be useful to the model's detection capability.

In some implementations, the feature space at the node is in general not uniformly occupied, and the central region may be important for clustering purposes. A high fidelity probability region (i.e., in the vicinity of the cluster centroid) can be found from the class probability distribution using a threshold probability, and this radius demarcates two regions of different detection capabilities. The method determines the class probability of the new dataset by comparing the distance to the cluster centroid and the high fidelity radius. If the new data falls into a high-fidelity central region, the threshold probability is assigned to the new data. Otherwise the left-over class probability on the node is assigned to the new data. The performance of the method on transaction datasets has been demonstrated to be better than that of both the decision tree alone model and the performance of method improves with smaller central regions. The clustering information on each node, including the high-fidelity radius and the inherent characteristics of each cluster, is helpful in identifying the temporal changes of transaction patterns.

In some other implementations, a system and method are presented for enhancing transaction fraud detection capability. This involves a machine learning method and enhancement classifier. In particular, the machine learning method includes a decision tree which classifies incoming transactions using leaf nodes. The internal nodes correspond to features extracted from the transaction datasets, and each out-going branch from an internal node corresponds to a value for that feature. The enhancement classifier includes a clustering algorithm on the tree nodes and a novel method to make use of the characteristic distribution of the dataset at the nodes.

Those skilled in the art will appreciate that the systems, methods and techniques described above can also be augmented with derived features. A raw feature, such as transaction amount for example, can be used to derive a new feature such as an average over a few days to better identify fraudulent characteristics. Those derived variables are mingled with the raw variables to form a feature set. Note not all the features have the same significance in contributing to the classification capability, and thus only a limited and practical pool of features should be used in the model construction. In addition, business knowledge may be used in the procedure of selecting final variables.

Typical datasets have different features that are on different scales. The dataset may be further converted to a standard form based on the training dataset's distribution. Namely, an assumption is made such that the training dataset accurately reflects the range and deviation of feature values of the entire distribution. Therefore all data samples may be normalized, for example, into a form of:

(Instance value−average_value)/(standard_deviation)

where average_value and standard_deviation are the mean and standard deviation of all the instances, respectively. Other forms of normalization can be used, such as normalizing features into fixed ranges for example of (−1,1) or (0,1) linearly and proportionally.

In some implementations, a method includes two phases: a training phase and a testing phase. For example, historical transactions containing labels can be used in the training phase to build a machine learning model. Thus the machine learning model is data-driven. In the testing phase, transactions in a given testing dataset are fed into the built machine learning model, and a label for each transaction is predicted based on the features in the current transaction and compared to the actual classes, as they appear in the testing dataset, represented in an accuracy measure to assess the performance of the built learning model.

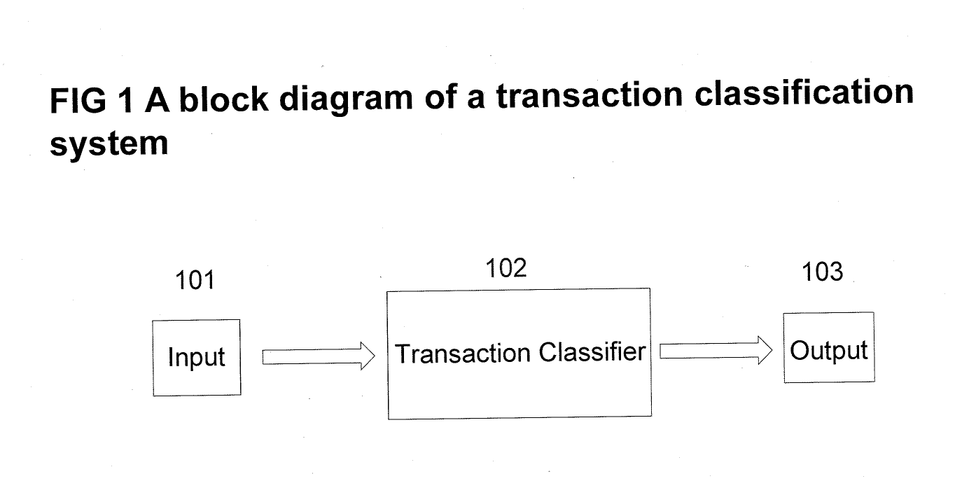

FIG. 1 is a block diagram illustrating a transaction classification system in accordance with some implementations. The transaction classification system includes a transaction classifier system 102 that receives an input 101 and provides an output 103. The input can be a transaction, for example, which may involve many features extracted and derived from the transaction. The classifier system is a model that is fed with the features generated by input 101. The model may include a neural network model like Falcon® model, decision tree learner for example. The transaction is classified by the classifier and the resulting classification is provided as the output 103. The transactional features as input into the classifier may include time characteristics, geographic characteristics, transaction amount etc. in the dataset. Different machine learning approaches utilize different forms of expressions for the classification. For example, a neural network model feeds the transactional data into a neural network and generates the classification based on the combined contributions from all the relevant hidden nodes. A decision tree classifies the transaction by traversing the sample through a built tree. The transactional features are compared with the feature splits at each decision node and eventually arriving at a leaf node. The likelihood of each class is determined by the leaf nodes in the training phase, which may set forth the decision tree model with the pre-determined classifications at each node and samples at each node for further analyses.

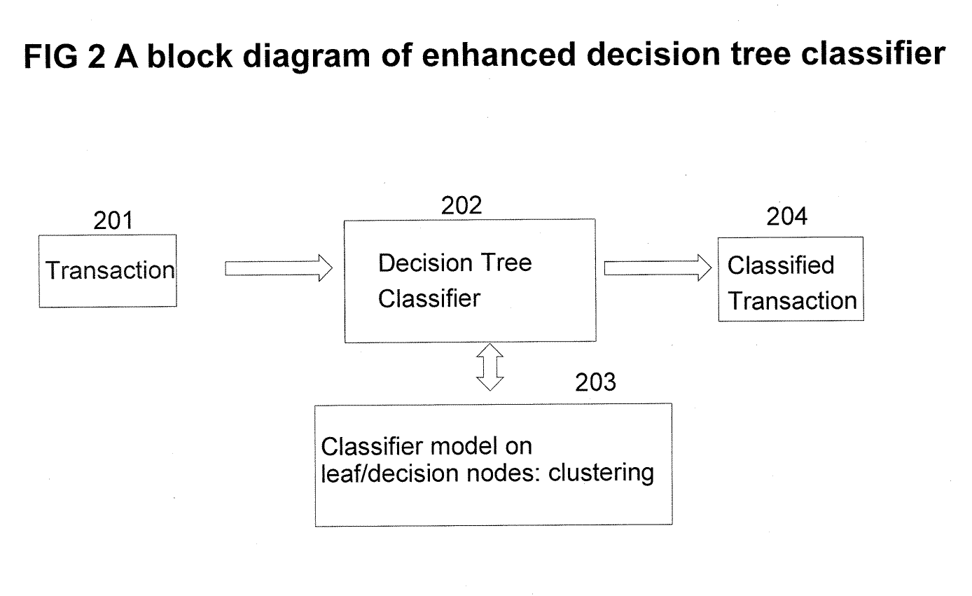

FIG. 2 is another block diagram of a transaction classification system in accordance with some implementations. The classification system includes a decision tree classifier 202 that takes a transaction 201 and provides a classified transaction that characterizes the features of the transaction. As an example, a decision tree is constructed by an algorithm such as C4.5 using a training dataset, and provides a likelihood of each class for a new (test) transaction by running the sample through the tree until reaching a leaf node. At the leaf node, the numbers of samples belonging to different classes may vary, thus typically the proportions of populations of each class are determined and set forth as a likelihood of each target class. Note that from the root to the leaf node, a transaction traverses a limited number of decision nodes to reach a leaf node. In other words, only a few features are utilized to split at decision nodes and a vast majority of the features are not used at all, so the samples at the leaf node are generally functions of the other features of the transaction. In fact, from a geometric point of view, a decision tree represents a partitioning of the data space of multi-dimensions. Each tree node contains a fraction of samples that have been band-filtered by the traversed features along a pathway. A decision or leaf node represents a data cube bounded into a sub-volume under the conditions at the traversed nodes, but not bounded by other feature dimensions on the traversal path. Thus in the following, only the features not present in the passing nodes along a pathway from root to node are utilized for feature distribution investigations.

The samples at each decision node or leaf node are thus partitioned datasets filtered by the traversed splits (nodes). The distribution of the samples in the feature space and population of the samples may vary from node to node. For example, the samples at some nodes may be oriented toward the time characteristics while samples at other nodes may be oriented on the geographic characteristics.

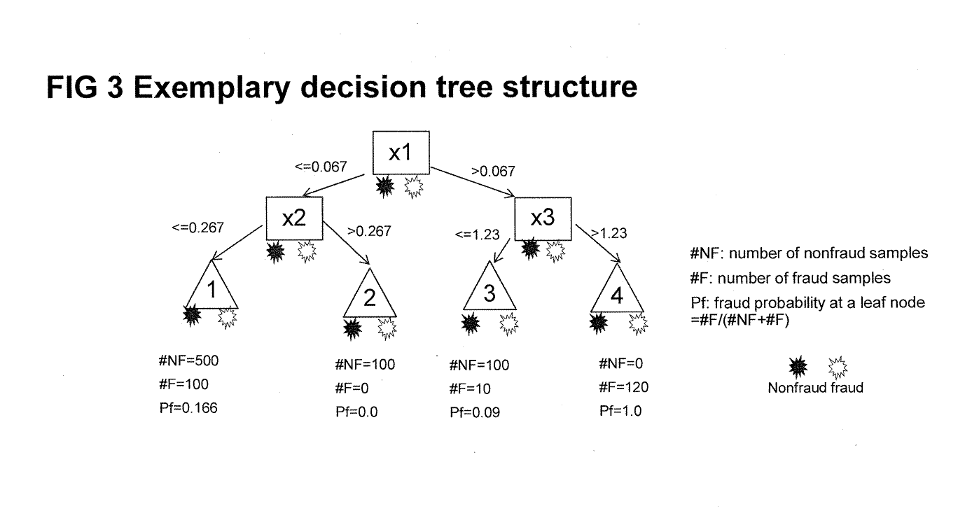

FIG. 3 illustrates an exemplary decision tree structure. A decision tree is built using the training dataset by an algorithm such as C4.5, which uses a gain ratio as a split method. In the plot shown, X1 is the root node split on variable X1 and then two branches are formed. One branch is split on X2 (variable) and yields two leaf nodes 1 and 2. On the other hand the other branch is split on X3 (variable) and yields to leaf nodes 3 and 4. Note that on each leaf, the numbers of each individual class might be different and they are determined by the training dataset. For example leaf node 1 has 600 samples and leaf node 2 has 1000 samples. Also on each node the relative count of each class may vary. For example node 1 has 500 nonfrauds vs 100 frauds while leaf node 3 has 100 nonfrauds versus 10 frauds. The decision tree model is a data-driven model, therefore the built tree is solely determined by the characteristics of the training dataset.

In a decision tree model, the class classification of a new transaction is only dependent upon the leaf node which is reached by the transaction data and is thus determined by the sample counts of each individual class. For example in FIG. 3, in a bi-modal (nonfraud and fraud transaction) case, the decision tree (built from the training dataset) has 500 nonfrauds and 100 frauds on a leaf node 1, therefore the probability of fraud on the leaf node corresponds to approximately 100/(100+500)=0.166. This probability may be referred as leaf node classification probability on this node because it simply counts the number of samples of each class to calculate class probabilities. The resulting models are referred to herein as decision-tree-alone models. The classification of such an approach leaves out the feature distribution of the data samples at each leaf node; such information in the feature space may be important for fraud detection.

As described further below, a system and method as described herein can be utilized to obtain insightful structuring of the data samples at leaf nodes. Usage of the feature distribution on the nodes may enhance desired information such as detection capability. Instead of looking into only the sample counts, the present invention further looks into the closeness or similarity of the new transaction in the feature space to the existing training samples on each leaf node.

To accomplish this task, the training samples on the leaf node may be clustered using a clustering algorithm like K-means method so new transactional data can be classified with the characteristics of the clusters. The novel enhanced detection algorithms described herein are based on an assumption that the distribution of the samples in a cluster is heterogeneous in the sense that the density of samples or resolution is higher in the vicinity of the cluster centroid relative to that far away from the centroid.

A clustering algorithm finds the intrinsic structure of a dataset at the nodes by organizing data into similarity groups or clusters. Within a cluster, data points are grouped as similarly as possible according to some distance measure on the transaction data features while the data points are made as dissimilar as possible for different clusters. Clustering algorithms (e.g., K-means) typically do not utilize the class label of each data point available for classification, and the clusters are formed based only on the feature similarities of the transactional samples, hence the induced clustering would not represent the classification problem. In some implementations, a clustering algorithm can be applied to the labeled training datasets so that the resulting clusters can be further assigned with relevant class probability. The class probability in each cluster can be utilized to classify new transactional data if the cluster is the closest to the new data and within a defined radius.

A variety of algorithms are known for data clustering. A popular one is the K-means algorithm which relies on the minimal sum of Euclidean distances to centers of a cluster. A K-means algorithm is described in an example below, however the method is not restricted to only the K-means algorithm, instead, other clustering methods can be used, such as expectation maximization.

In the K-means method, the Euclidean distance is typically defined the square root of the sum of the squares of the difference between each variable (feature) associated with the k-means computing. The vector of features for each transaction is a data point. Namely, the data points are generally expressed by multidimensional arrays and the content is feature values of the transaction. The clustering algorithm utilizes the distance as measure to group samples (data points) into a plurality of subsets according to some inherent similarity measure between data within the dataset. Once the clusters are formed, then the cluster centers (centroids) may be given by those data points in the cluster:

$$cluster center = 1 / N {\sum }_{i = 1}^{N} Xi$$

where X is a feature variable and N is the total number of samples in a cluster. Other forms of expressions can be used, such as a weighted mean of the samples, to determine the centroids of clusters. The K-means clustering algorithm works by re-assigning all data points to the closest centroids and re-calculating the centroids of each cluster. The process repeats iteratively until a termination criterion is met or no change is found in the centroids of the clusters.

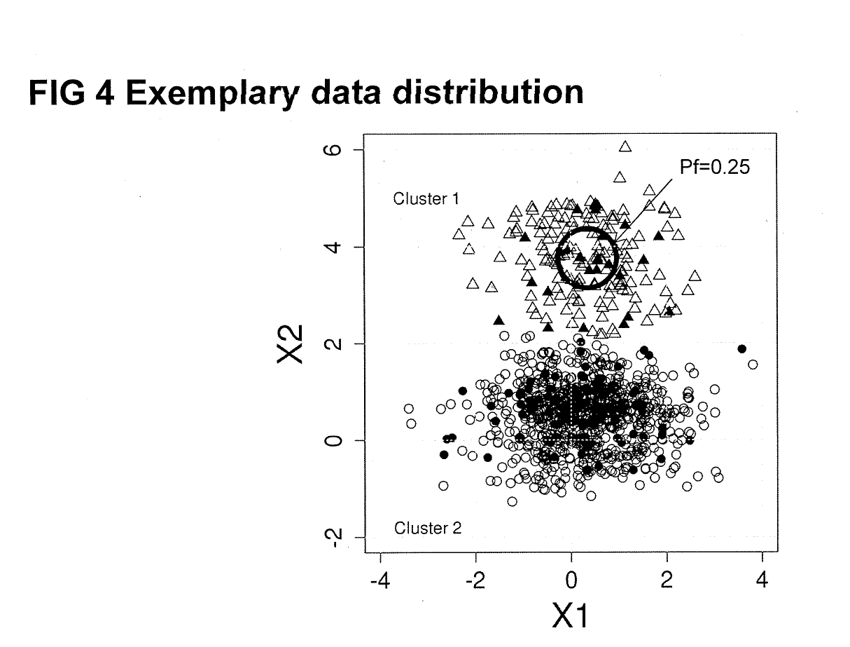

FIG. 4 shows exemplary clusters of the training dataset at a leaf node in a bi-modal case. Axes X1 and X2 are two feature variables. The data points denoted with small circles belong to cluster 1 (upper) and those data points denoted with triangles belong to cluster 2 (lower). In this example, two clusters may have different data distributions and populations of samples, for example, cluster 2 having more samples than cluster 1.

Continuing with the illustrated example of FIG. 4, the samples in each cluster are composed of both nonfraud and fraud samples in the bi-modal case since the samples are from the training set and so all labeled. Solid symbols (solid circles and solid triangles) indicate fraud samples while void symbols (void circles and void triangles) indicate nonfraud samples in each cluster. The distributions of the clusters demonstrate the heterogeneities of the training data set on the node. The relative populations or concentrations of the nonfraud and frauds may vary from cluster to cluster. In the classic clustering approach, the fraud probability of each cluster may be obtained using the relative populations of the two classes in the bi-modal case. For example in a bi-modal case, there are two clusters, namely cluster 1 and cluster 2. If there are N1 nonfraud samples and F1 fraud samples in a cluster 1, the fraud probability of this cluster 1 is obtained by

P1=F1/(N1+F1)

which is the cluster class probability of the cluster 1. Cluster 2 may have a different distribution and its fraud probability may be also expressed in a similar form of

P2=F2/(N2+F2)

as the cluster class probability of cluster 2 (N2 and F2 are numbers of nonfrauds and frauds respectively). In the classic clustering approach for the bi-modal case, one of the two cluster class probabilities (P1 or P2) may be assigned to a new transactional data reaching a leaf node, depending upon the distances between centroids and a new transactional data. For example, if the new data point is closer to the centroid of the cluster 1, the fraud probability of the new data is assigned as P1, otherwise it is assigned to P2. Such a clustering approach leaves out the feature distribution in each cluster, so the fraud probability of each cluster is only characterized by the cluster class probability such as P1 and P2 as illustrated in the above example.

Note that in the decision tree alone model (i.e. no clustering at tree nodes at all) in which the feature distribution at each node is not considered, the fraud probability is simply calculated as the aggregated quantity:

Pn=F/T

(F=F1+F2, T=total number of samples=N1+N2+F1+F2)

Such a method indicates that all the samples at the node are utilized with the same weight to obtain the leaf node class probability. This leaf node class probability Pn is the only probability on the node which is to be assigned to the new data arriving at the leaf node in the decision-tree-alone model. In general the three probabilities P1 of cluster 1, P2 of cluster 2 and Pn of the leaf node may be all different, all being related to the population and distribution of the samples, and especially, P1 and P2 certainly contain insightful information on the characteristic distributions of the samples in the feature space for the training dataset on a node.

To classify a new transactional data arriving at a leaf node, the classic clustering approach calculates the Euclidean distance to each cluster. The new data is thus classified based on the closeness or similarity to each cluster. Namely, in the bi-modal case, if the Euclidean distance to cluster 1 is shorter than to cluster 2, the transactional sample is assigned to cluster 1 (the sample is said to have a membership of cluster 1) and thus fraud probability is set to the cluster probability P1. Otherwise the new sample is assigned to cluster 2 (i.e., it has a membership of cluster 2) and the fraud probability of the new sample is set to the cluster probability P2.

Using the shortest distance to clusters to determine the cluster membership provides a straightforward way to classify a new transactional data. However further investigations on the samples indicate that in general the clusters may not be tightly concentrated in a small region, on the contrary, they may spread out over a large region so that the simple approach using only the cluster probability of each cluster may not yield good classification results since the detection capability varies due to the data distribution in a cluster as seen in FIG. 4. The circle in cluster 1 is centered at the centroid of the cluster and the radius corresponds to a fraud probability of 0.25 which is calculated by counting the numbers of nonfraud and fraud samples falling within the circle.

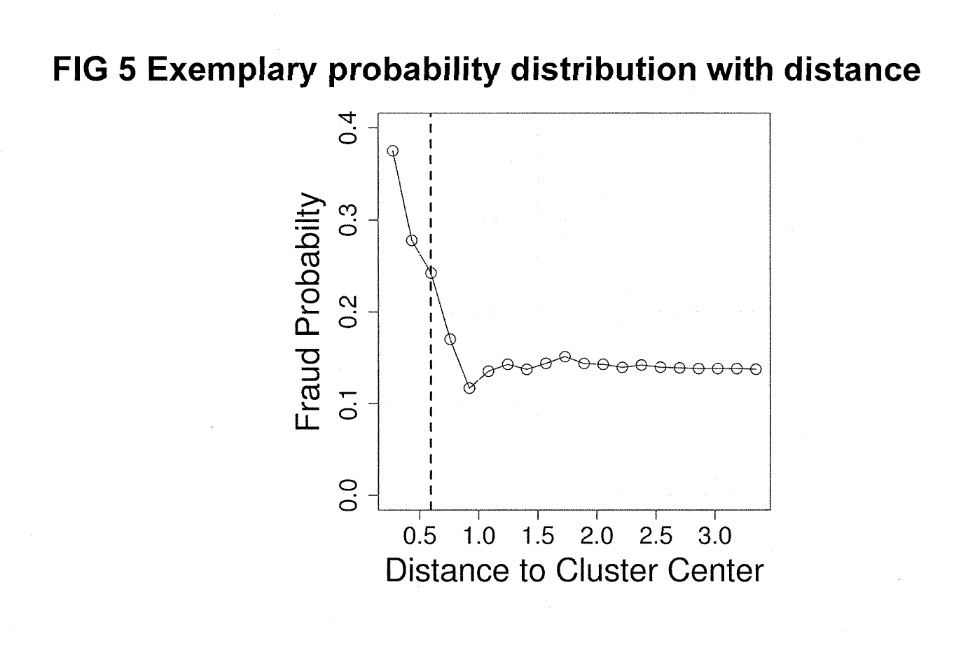

FIG. 5 shows an exemplary class probability distribution of one cluster (cluster 1). The horizontal axis indicates the Euclidean distance (radius) from the cluster center and vertical axis indicates the probability of class (fraud in this example). The curve is obtained by starting at the cluster centroid, extracting all the samples inside a circle of a given radius (distance from the centroid) and dynamically calculating fraud probability by counting the fraud and nonfraud samples in the encircled region. In general case, the class probability varies with the radius or distance from the cluster centroids.

The example shown in FIG. 5 depicts that the class (fraud) probability falls quickly as the radius increases and then approximately flattens out at a large radius. The level-out value (˜14%) may correspond to the cluster fraud probability which is typically used in the classic clustering classification. Thus the classic approach leaves out the distribution of the data points in individual clusters and neglects the lack of homogeneity in the leaf-node class overall.

In accordance with some implementations, the distribution of the class probability versus distance to the cluster center may be used to enhance the detection capability. The class probabilities are derived from the labels of the samples in the training dataset. Since the class probability varies with distance (i.e., the class probability is not uniform at all radii), a characteristic radius may be defined such that the probability on the two sides of the radius may be different (the classic approach may just use one cluster probability). The data space at the node is in general not uniformly occupied, so not every data point is equally important for clustering purposes. For example, the inner region of the radius may have a high-density of the samples while the outer region may have lower-density samples on average. The characteristic radius may be obtained by calculating the class probability progressively from the cluster centroids until the class probability reaches a preset class probability (threshold) so that the inner region is differentiated from the outer region on the sense that two different detection capabilities are obtained.

For example the fraud probability falls from 0.38 to 0.25 around radius of 0.6, namely the nonfraud probability (=1-fraud probability) increases from 0.62 to 0.75, indicating that the class probability of samples being nonfraud is 0.75 inside the region bound by radius of 0.6. The dashed line in FIG. 5 indicates the location of the radius r=0.6, corresponding to the fraud probability of 0.25 (nonfraud probability is thus 0.75). Therefore, choosing a threshold for example, 75%, as a high fidelity (confidence) estimation of class, the radius is thus obtained by finding the smallest radius with a class probability of 0.75. The radius (e.g., 0.6 in the example) may be referred as high-fidelity radius Rh. This radius Rh of each cluster at each node is determined by the training dataset and reflects some characteristics of the transactional samples. Such a preset class probability P and the radius Rh, which is closely related to the inherent characteristics of the training dataset, may be utilized to classify the new transactional data in the method.

A new sample which falls within the radius of a cluster may be assigned with the preset class probability (for example, radius <=0.6, probability=0.75 for nonfraud in the above example). For any sample which falls outside all of the high-fidelity radii of all the clusters, the sample is assigned as a fraud probability of the training samples outside all the Rh's. This probability is calculated by counting all the samples outside the Rh's on the leaf node and the probability so defined may be referred as left-over class probability of the node, which may be written as

$${P}_{leftover} = \frac{( FN - {\sum }_{j = 1}^{N} {F}_{j} )}{( TN - {\sum }_{j = 1}^{N} {T}_{j} )}$$

where FN and Fⱼ denotes total number of fraud samples on the node and number of fraud samples inside its radius of Rh in the jth cluster, TN and Tⱼ denotes total number of all the samples on the node and number of all the samples inside its radius of Rh in the jth cluster and N is the number of the clusters on the node.

The class probability settings include a threshold probability of each cluster (which is same for all the clusters) for the subspaces within the high-fidelity radii, and the leftover class probability for the rest of the feature space. The feature space is virtually partitioned into N island-like sub-regions and a background sub-region which is characterized as a leftover probability and spans the sparsely distributed region. The leaf probability can be used for the background sub-region, and the difference in classifications may be related to the underlying feature distributions but the leftover class probability designation can provide a straightforward representation of the piecewise classifications in the method.

According to some implementations, a fraud detection model can be built from the training dataset in the following steps:
1) Building a decision tree using the training dataset with an algorithm such as C4.5 algorithm
2) At tree nodes, using clustering algorithm such as K-means, to group the dataset into clusters
3) For each cluster, calculating the high-fidelity radius Rh with the preset class probability and the left-over class probability of the node
4) Saving the decision tree model and the resulting parameters to classify new transactional data.

Once the model is trained by the training dataset, the procedure to classify a new data with the method at a node may include in some embodiments:
1) Find the closest cluster by calculating the Euclidean distance between the new data point to the centroid of each cluster
2) Compare the Euclidean distance with the radius Rh of the assigned cluster. If the Euclidean distance of the new data to the cluster centroid is shorter than the Rh, the new data is classified with the pre-set class probability of this cluster.
3) Otherwise the new data is classified with left-over class probability of the node.

The method combines the classification approaches of the decision tree and clusters. The algorithm of the former provides the general classification for the new transactional data outside the high-fidelity radii (using left-over class probability), while that of the latter provides the classification if the new transactional data falls into within the radius Rh. The leaf probability of the node can be used instead of the left over class probability (excluding the samples in the defined central regions) and the same algorithm still holds. Since the decision tree classification gives a uniform label for all the samples at the node on a coarser scale, but the clustering approach divides the data into groups and sets the labels on a finer scale, the hybrid method can take advantage of both methods and enhance the detection capability of a decision tree learner that is always a data-driven model and in which the data and feature distribution is the centerpiece of the method.

The algorithm above implies that a key is that the training samples near the cluster's centroids are better classifiers. The classification capability becomes lessened with increasing distance from the cluster centroids. The pre-set class probability is used to obtain the radius Rh. Various methods can be used to define the region or radius that demarcates two regions of different detection capability. For example, one alternative approach may include using the percentage (e.g., 80%) of the peak class probability or average probability in the vicinity of the cluster centroid to find the radius Rh of a cluster. Also more than two regions can be defined based on the class probability distribution with distance and the similar steps described hold for the piecewise scheme.

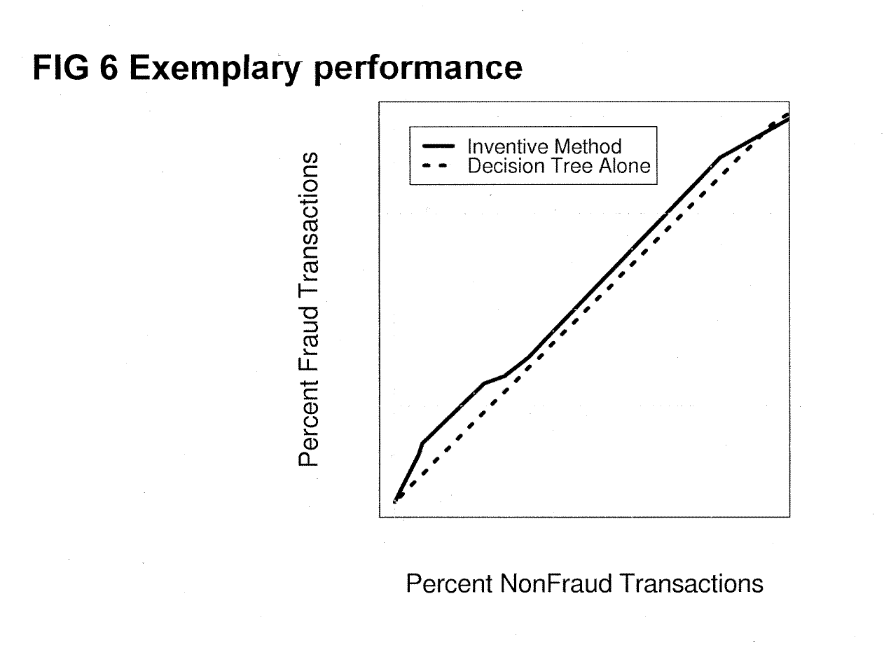

FIG. 6 illustrates a performance of an exemplary method compared with the decision tree alone model in a bi-modal case. Performance of a model is commonly measured by so-called “receiver operating characteristics” (ROC). The ROC graph examines the percentage of good (horizontal axis) versus the percentage of bad (vertical axis). The higher percentage of bad at a given percentage of good indicates better detection capability. In the example the decision tree is built from a transaction training dataset and the two clusters are obtained on each leaf node. The cluster centroids and the characteristic radii (high fidelity radius) are all calculated and saved on the leaf node.

The testing dataset is input to show the performance of the built hybrid model. The testing dataset is disjointed from the training set. Each sample in the testing dataset traverses the built tree and arrives at a leaf node. The class classification if each testing sample is obtained via 2 methods for comparison: 1) decision tree alone, that counts the class numbers of the samples at each node; 2) the new inventive hybrid method of decision tree and clustering method. The new transactional sample is classified by using the characteristic parameters of the cluster (e.g., high fidelity radius, preset class probability, left-over class probability).

Performance of the two models shown in FIG. 6 are depicted together as a dotted line (only decision tree, without clustering) and solid line (decision tree and the new method on nodes). The performance of the new method shows clearly better performance than the decision tree alone model, i.e., for a given percentage of good samples, the percentage of bad samples is higher for the method than the decision tree alone method. The comparison results demonstrate that the training samples near the cluster centroids have better detection capability as described above, and indicate that the method may enhance the detection capability of the classic decision tree approach by augmenting an additional classifier on the tree nodes. The reasons may include the decision tree alone method only classify the samples on a coarser scale without considering the feature distribution and the method may further refine the classification on the finer scale by clustering the samples together with using the high-fidelity classification characteristics, as seen in the examples.

The model performance of the method may depend on some factors such as the inherent feature distribution and the threshold to split the region of the clusters. In some implementations, the threshold of the class probability may determine the high-fidelity radius and thus the performance of the resulting model. The performance may improve with smaller thresholds and more clusters for adequate data distribution since the central region (radius less than Rh) in the vicinity of the cluster centroids may present better discrimination capability.

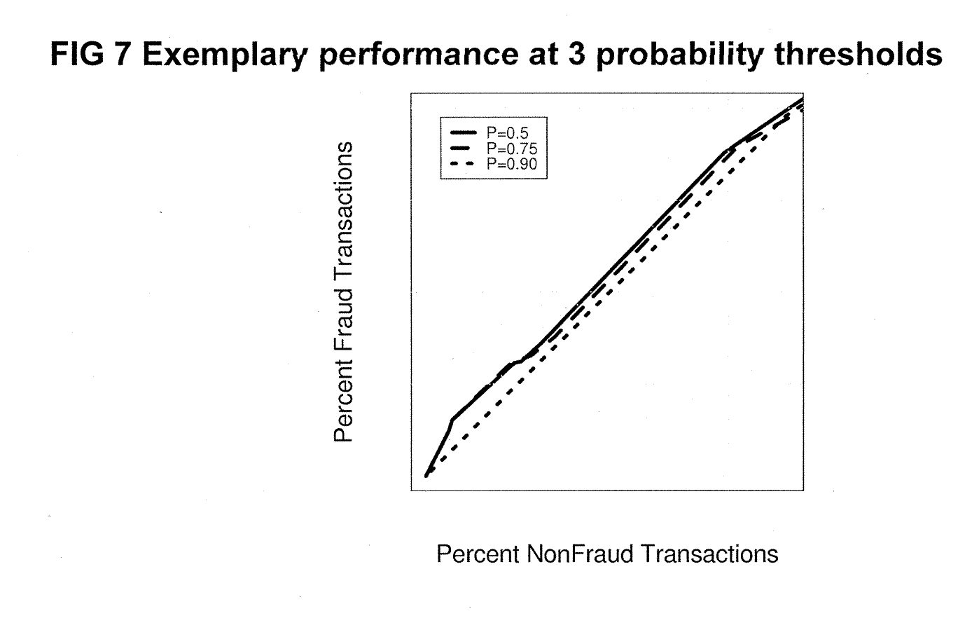

FIG. 7 shows the performance comparisons of the method using three different preset class probability thresholds. The three thresholds include P=0.50, 0.75 and 0.90. The performance results (ROC results) are plotted with solid line, long-dashed line and short-dashed line for the probability of P=0.50, 0.75 and 0.90 respective. At a threshold of 0.90, the performance approaches that of the decision tree alone method since the central regions may be so large that the resulting performance may get close to the performance on the coarse scale, like the leaf probability. FIG. 7 shows that the performance improves in general with the decreasing thresholds from P=0.90 which may correspond to the rough scale estimate to P=0.5 which may correspond to the fine scale estimate by using smaller central regions.

Some implementations of the method are illustrated with samples at the leaf node above. In fact this method may be used on the decision nodes as well. For each sample, a few classifications can be obtained on the decision nodes on the path from root to a leaf node. The final classification of the transaction data may be represented as a function of all the probability on all the traversed nodes within a tree. The probability may be a weighted average of the probabilities on the path from root to leaf or other functions such as minimum or maximum values within some thresholds. The weighted average or other operations on the probabilities are useful in detection.

The method described above is illustrated for the bi-modal case. In fact this method may be used in a multi-modal case. In such cases the class probabilities are calculated for all the classes in the training dataset. The classification of a new transactional data is thus composed of probability for each class.

The method described above has been tested on the in-time dataset, that is, the training dataset and testing dataset (which is disjoint from the training dataset) are both from the transactions made in the same year and the class distribution may be similar. The method has further been tested on the out-of-time dataset which includes the transactions made in a different year from the training dataset year. The performance of the method is found to be better than that of the decision tree alone method as well which is important as it means that the results are operationally and commercially viable improvements to business practices.

The clusters and the pertinent high-fidelity radius may be determined by the training dataset and they may be used to investigate the characteristic changes in the transaction datasets with time. The training samples on nodes are clustered by the feature distribution such that the statistics of new data falling into each cluster and location are useful to characterize the temporal changes in the datasets. For example, in an N-mode case, the number or percentage of the samples falling into the high-fidelity regions, denoted as Sᵢⱼ, i=1 to N and j=1 to number of nodes, may exhibit changes for the datasets of different times. A summed difference Σ_{i,j}|Sᵢⱼ¹−Sᵢⱼ²| (superscripts 1 and 2 indicate two different times) or other measures may be used to calculate the changes and the measure may be compared with a threshold to determine whether a significant change occurs. The difference on individual modes may also indicate a change in a subpopulation of the dataset. For example, one mode is a cross-border cluster and the significant change of population on the mode indicates the transaction patterns may shift over this subpopulation. The change of the patterns revealed by the method on the detailed subpopulation may be useful for clients to focus on the important segments.

For enhancing detection capability of frauds in the feature space, a decision tree is built to partition the dataset into subsets at each leaf node, and then the first embodiment is to apply a cluster-based algorithm to the labeled data samples at each node. The class probability may differ in each cluster due to the difference in population and distribution of the samples in each cluster. Some implementations include an algorithm to obtain a high fidelity radius Rh from the cluster centroid under the preset class probability. The samples are better classified within the radius Rh of a cluster. New transactional data traverses the built decision tree from the root to a leaf node, and then is classified in two steps according to some of the embodiments: 1) determining its membership to a cluster of the shortest distance to the cluster centroid; and 2) determining whether it is inside the high fidelity radius Rh (distance from the cluster centroid). If it falls inside the radius, the classification is set as the preset probability; otherwise it is set the left-over class probability on the node. The resulting performance has been demonstrated in the above to be better than that of the decision tree alone model.

The clustering approach on top of the decision tree involves separating a dataset at the leaf nodes into a plurality of subsets (i.e., clusters) according to some inherent similarity measure between data within the dataset on a tree node. The clustering algorithm may induce some extra expense in building a hybrid decision tree model. As described above, the decision tree partitions the entire dataset into small chunks, depending on its intrinsic feature distribution, and the dataset is distributed onto many nodes so that the clustering is performed on the small partitioned datasets. The clustering may also be needed only once after the decision tree is built, and then the hybrid model may be used to classify new dataset again and again if necessary in a production application.

In some implementations, a computer-implemented method for detecting frauds in a plurality of transactions included in a dataset includes the steps of building a decision tree with training data in a dataset, clustering the samples on each tree node with a clustering algorithm, and calculating the centroid for each of the clusters on a node. The method further includes obtaining the high-fidelity radius for each cluster for a class probability threshold and the left-over class probability on the node, and applying the resulting clustering parameters with the decision tree model to classify new data. The training data may be normalized using the mean value and standard deviation of the original dataset.

Clustering the samples on each node can include choosing a number of clusters to be formed on each node, using a k-means algorithm to cluster training data samples, and performing the clustering algorithm only on the left-over dimensions in the feature space. The left-over dimensions are defined as those dimensions not appeared in any nodes along the pathway from root to the node, and the centroid of each cluster is calculated by averaging the values in each dimension of the left-over feature subspace.

In accordance with some implementations, calculation of the high-fidelity radius can include a method to generate a class probability distribution with distance from the centroid of a cluster, and/or a search method to locate the radius where the probability is greater or equal to the threshold probability. The threshold probability is an input parameter to calculate the central region of each cluster for high-fidelity classification.

In accordance with some implementations, calculation of the left-over class probability includes counting the number of fraud samples in the training samples outside the high-fidelity sub-regions, counting the total number of all the samples in the training samples outside the high-fidelity sub-regions, and taking the ratio of the count of number of fraud samples to the total number of all the samples to obtain the left-over class probability of the node. The left-over class probability is associated with the input threshold probability and the sample distribution.

In accordance with some implementations, classifying a new data can include the steps of calculating the distance to each cluster centroid and select the cluster which has the shortest distance, and comparing the distance to the high fidelity radius of the cluster. If the new data is located inside the radius, the class probability of the new data is set to be the threshold probability. Otherwise the class probability of the new data is set to be the left-over class probability of the node. The distance is calculated as a Euclidean distance between two data points.

The dataset used to build a tree model can include transaction data such as, without limitation, credit card, debit card purchases, DDA/current account purchases, mobile banking, online banking, and Cyber Security-monitored entities. The distribution of samples falling into the high fidelity regions may indicate the temporal changes of the transaction or fraud patterns from datasets in two different times.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT), a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method for detecting fraud in a plurality of transactions in a dataset, the method compromising:
building, by at least one data processor, a decision tree with training data in the dataset, the training data comprising data representing the plurality of transactions, the decision tree having one or more tree nodes comprising one or more leaf nodes that indicate a value of a target attribute value and one or more decision nodes that specify a condition to be executed by the at least one data processor on a single target attribute value of one or more leaf nodes, and having branches that logically connect pairs of the one or more leaf nodes and/or decision nodes;
storing, by at least one data processor, a plurality of samples of an output of the condition executed on the single target attribute value;
clustering, by the at least one data processor executing a clustering algorithm, the plurality of samples on related tree nodes to generate one or more clusters of samples;
for each of the one or more clusters on each related tree node:
calculating, by the at least one data processor, a centroid for each cluster; and
calculating, by the at least one data processor, a high-fidelity radius for each cluster for a class probability threshold and a left-over class probability on the related tree node to define a set of clustering parameters; and
applying, by the at least one data processor, the set of clustering parameters on new data to the dataset to classify the new data as either the class probability of a specific cluster of the one or more clusters or the left-over class probability associated with the leaf node.

2. The method in accordance with claim 1, wherein the training data is normalized using a mean value and a standard deviation of the dataset.

3. The method in accordance with claim 1, wherein clustering the plurality of samples on related tree nodes further comprises:
selecting a number of clusters to be formed on each node; and
using a K-means algorithm to cluster training data samples, executing the K-means clustering algorithm only on left-over dimensions in a feature space.

4. The method in accordance with claim 3, wherein the left-over dimensions are dimensions that do not appear in any nodes along a pathway from a root of the decision tree to the selected node.

5. The method in accordance with claim 3, wherein the centroid of each cluster is calculated by averaging the values in each dimension of the left-over feature subspace.

6. The method in accordance with claim 1, wherein calculating the high-fidelity radius further comprises:
generating a class probability distribution with a distance from the centroid of a cluster; and
locating a radius where a probability is greater or equal to a threshold probability.

7. The method in accordance with claim 6, wherein the threshold probability is an input parameter to calculate the central region of each cluster for high-fidelity classification.

8. The method in accordance with claim 1, wherein the left-over class probability is calculated by:
counting a number of fraud samples in the training samples outside the high-fidelity sub-regions;
counting a total number of all samples in the training samples outside the high-fidelity sub-regions; and
calculating a ratio of the count of number of fraud samples to the total number of all the samples to obtain the left-over class probability of the node.

9. The method in accordance with claim 8, wherein the left-over class probability is associated with the input threshold probability and the sample distribution.

10. The method in accordance with claim 1, wherein classifying the new data further comprises:
calculating a distance to each cluster centroid;
selecting a cluster having the shortest distance; and
comparing the distance to the high fidelity radius of the cluster.

11. The method in accordance with claim 10, wherein if the new data is located inside the high fidelity radius, the class probability of the new data is set as the threshold probability, otherwise the class probability of the new data is set as the left-over class probability of the node.

12. The method in accordance with claim 10, wherein the distance is calculated as a Euclidean distance between two data points.

13. The method in accordance with claim 1, wherein the data to build the tree model is transaction data including credit card, debit card purchases, DDA/current account purchases, mobile banking, online banking, and Cyber Security monitored entities.

14. The method in accordance with claim 1, wherein the changes in distribution of samples falling into the high fidelity regions represent temporal changes of the transaction or fraud patterns from datasets from at least two different times.

15. A system comprising
at least one programmable processor; and
a machine-readable medium storing instructions that, when executed by the at least one processor, cause the at least one programmable processor to perform operations comprising:
build a decision tree with training data in the dataset, the training data comprising data representing the plurality of transactions, the decision tree having one or more tree nodes comprising one or more leaf nodes that indicate a value of a target attribute value and one or more decision nodes that specify a condition to be executed by the at least one data processor on a single target attribute value of one or more leaf nodes, and having branches that logically connect pairs of the one or more leaf nodes and/or decision nodes;
store a plurality of samples of an output of the condition executed on the single target attribute value;
cluster the plurality of samples on related tree nodes to generate one or more clusters of samples;
for each of the one or more clusters on each related tree node:
calculate a centroid for each cluster; and
calculate a high-fidelity radius for each cluster for a class probability threshold and a left-over class probability on the related tree node to define a set of clustering parameters; and
apply the set of clustering parameters on new data to the dataset to classify the new data as either the class probability of a specific cluster of the one or more clusters or the left-over class probability associated with the leaf node.

16. The system in accordance with claim 15, wherein the operation to cluster the plurality of samples on related tree nodes further comprises operations to:
select a number of clusters to be formed on each node; and
using a K-means algorithm to cluster training data samples, execute the K-means clustering algorithm only on left-over dimensions in a feature space.

17. The system in accordance with claim 16, wherein the centroid of each cluster is calculated by averaging the values in each dimension of the left-over feature subspace.

18. The method in accordance with claim 15, wherein calculating the high-fidelity radius further comprises:
generating a class probability distribution with a distance from the centroid of a cluster; and
locating a radius where a probability is greater or equal to a threshold probability.

19. The system in accordance with claim 18, wherein the threshold probability is an input parameter to calculate the central region of each cluster for high-fidelity classification.

20. The system in accordance with claim 15, wherein the left-over class probability is calculated by:
counting a number of fraud samples in the training samples outside the high-fidelity sub-regions;
counting a total number of all samples in the training samples outside the high-fidelity sub-regions; and
calculating a ratio of the count of number of fraud samples to the total number of all the samples to obtain the left-over class probability of the node.

21. The system in accordance with claim 20, wherein the left-over class probability is associated with the input threshold probability and the sample distribution.
